(19) United States
(12) Patent Application Publication
(10) Pub. No.: US 2024/0167671 A1
(43) Pub. Date: May 23, 2024

(54) PIVOTABLE JUNCTION BOX AND DRIVER HOUSING UNIT

(71) Applicant: SIGNIFY HOLDING B.V., EINDHOVEN (NL)

(72) Inventors: PHILIP DEAN WINTERS, CENTRE, AL (US); PERI WITHERS, ATLANTA, GA (US)

(21) Appl. No.: 18/283,080

(22) PCT Filed: Mar. 9, 2022
(86) PCT No.: PCT/EP2022/056055

§ 371 Date: Sep. 20, 2023

Related U.S. Application Data
(60) Provisional application No. 63/164,032, filed on Mar. 22, 2021.

(30) Foreign Application Priority Data
Jul. 5, 2021 (EP) 21183600.2

(51) Int. Cl. F21V 23/00; F21S 8/02; F21V 17/18; H02G 3/08

(52) U.S. Cl. CPC F21V 23/008; F21S 8/026; F21V 17/18; F21V 23/001; H02G 3/081

(57) ABSTRACT

A pivotable junction box and driver housing unit includes a junction box having a junction box cavity, and a driver housing having a driver housing cavity to contain a light fixture driver. The junction box and the driver housing are attached to each other. The junction box and the driver housing are rotatable with respect to each other.

### TECHNICAL FIELD

The present disclosure relates generally to lighting devices, and more particularly to a pivotable junction box and driver housing unit that is a combination of a pivotably attached driver housing and junction box.

### BACKGROUND

A combination driver housing and junction box unit typically has a driver compartment that contains a driver (e.g., LED driver) and a junction box compartment for making wiring connections. The typical combination driver and junction box unit that is installed after a ceiling is in place is designed to pass through an opening of a specific size in the ceiling. The length of the driver and junction box unit is generally limited by the size of the plenum space and the light fixture opening in the ceiling. For example, a relatively small plenum space (e.g., 2 by 4 constructed ceiling space) and a relatively small ceiling opening size (typically, 3 or 4 inches in diameter) can limit the size of a driver and junction box unit, and thus, the size of the light fixture driver (e.g., LED driver) that may be placed in the relatively small plenum space through the relatively small ceiling opening. Thus, a solution that allows for the installation of a relatively longer driver and junction box unit containing a relatively larger driver may be desirable.

### SUMMARY

The present disclosure relates generally to lighting devices, and more particularly to a pivotable driver and junction box that is a combination of a pivotably attached driver housing and junction box. In an example embodiment, a pivotable junction box and driver housing unit includes a junction box having a junction box cavity, and a driver housing having a driver housing cavity to contain a light fixture driver. The junction box and the driver housing are attached to each other. The junction box and the driver housing are rotatable with respect to each other.

In another example embodiment, a light fixture driver assembly includes a pivotable junction box and driver housing unit that includes a junction box having a junction box cavity, and a driver housing having a driver housing cavity. The junction box and the driver housing are attached to each other. The junction box and the driver housing are rotatable with respect to each other. The driver assembly further includes a light fixture driver positioned in the driver housing cavity.

These and other aspects, objects, features, and embodiments will be apparent from the following description and the appended claims.

### BRIEF DESCRIPTION OF THE FIGURES

Reference will now be made to the accompanying drawings, where:

FIGS. 1A-1C illustrate different views of a pivotable junction box and driver housing unit according to an example embodiment;

FIGS. 2A and 2B illustrate the pivotable junction box and driver housing unit of FIGS. 1A-1C in a rotated position according to an example embodiment;

FIGS. 3A and 3B illustrate the junction box of the pivotable junction box and driver housing unit of FIGS. 1A-1C according to an example embodiment;

FIGS. 4A and 4B illustrate the driver housing of the pivotable junction box and driver housing unit of FIGS. 1A-1C according to an example embodiment;

FIG. 5 illustrates a light fixture driver assembly including the pivotable junction box and driver housing unit of FIGS. 1A-1C according to an example embodiment;

FIG. 6 illustrates the pivotable junction box and driver housing unit of FIGS. 1A-1C during installation in a plenum space according to an example embodiment;

FIG. 7 illustrates a lighting system including the pivotable junction box and driver housing unit of FIGS. 1A-1C according to an example embodiment;

FIG. 8 illustrates a separable junction box and driver housing unit according to an example embodiment; and

FIG. 9 illustrates the junction box and the driver housing of the separable junction box and driver housing unit of FIG. 8 separated from each other according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals that are used in different drawings designate like or corresponding, but not necessarily identical elements.

### DETAILED DESCRIPTION OF EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

Some building construction techniques enable relatively tight plenum spaces that can pose challenges for lighting installation and wiring. At the same time, the need for increased light output requires relatively large power supplies that pose additional installation challenges. The limited plenum space along with light fixture openings that are limited in size can make installation of power supplies (generally referred to herein as drivers) challenging. In some example embodiments, a pivotable junction box and driver housing unit may be used to alleviate such challenges.

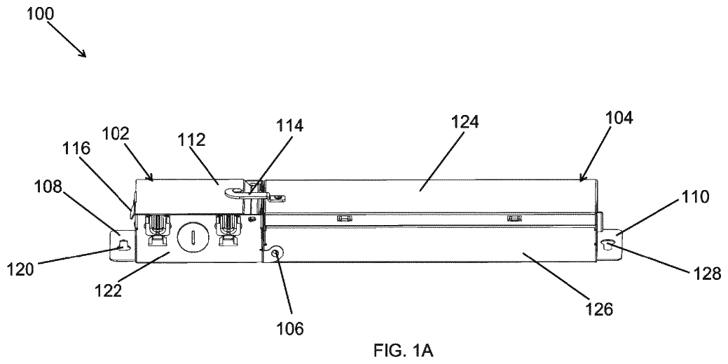

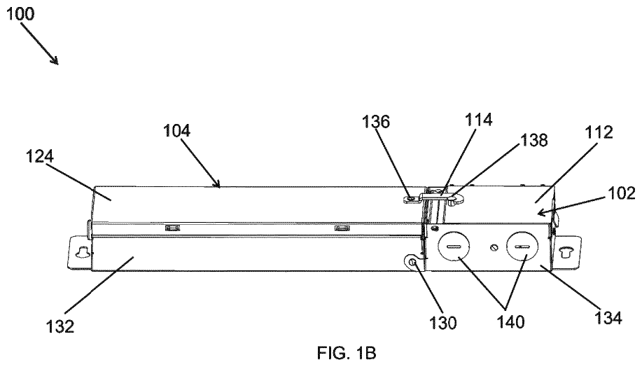

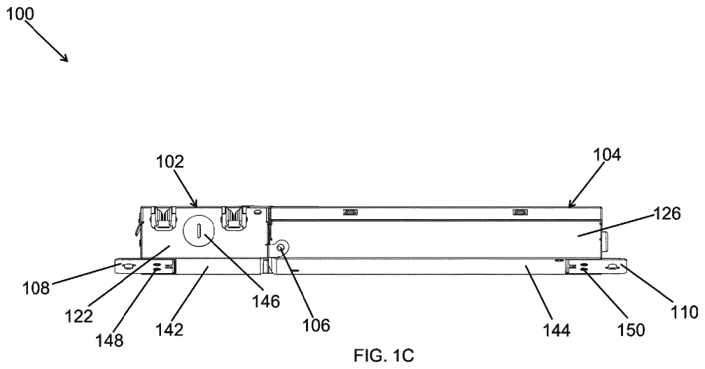

FIGS. 1A-1C illustrate different views of a pivotable junction box and driver housing unit 100 according to an example embodiment. The pivotable junction box and driver housing unit 100 is shown in a linear position in FIGS. 1A-1C. In some example embodiments, the pivotable junction box and driver housing unit 100 includes a junction box 102 and a driver housing 104. The junction box 102 and the driver housing 104 are pivotably attached to each other. To illustrate, the junction box 102 and the driver housing 104 may be attached to each other by a fastener 106 (shown in FIG. 1A) and a fastener 130 (shown in FIG. 1B). The junction box 102 and the driver housing 104 may each be rotatable with respect to each other while remaining attached by the fasteners 106, 130.

In some example embodiments, the junction box 102 may include a top cover 112, a side wall 122 shown in FIG. 1A, a side wall 134 shown in FIG. 1B, and a bottom wall 142 shown in FIG. 1C. The top cover 112 may include a tab 116 that may be used to lift up the top cover to expose a cavity of the junction box 102. Electrical connections between electrical cables and/or wires may be made inside the cavity of the junction box 102. For example, an electrical cable that is used to carry supply power (e.g., mains power) may be connected to one or more electrical wires. For example, the one or more electrical wires may be connected inside the cavity of the junction box 102 to one or more electrical wires of a driver (e.g., LED driver) that can be in a cavity of the driver housing 104. In some example embodiments, the driver housing 104 may include a top cover 124, a side wall 126 shown in FIG. 1A, a side wall 132 shown in FIG. 1B, and a bottom wall 144 shown in FIG. 1C. The top cover 124 may be lifted up and/or swung open to expose a cavity of the driver housing 104.

In some example embodiments, the pivotable junction box and driver housing unit 100 may be placed in a plenum space behind a ceiling and may be securely attached to the ceiling using mounting structures 108, 110 and fasteners. To illustrate, the junction box 102 may include the mounting structure 108, and the driver housing 104 may include the mounting structure 110. For example, the mounting structure 110 may be attached to the bottom wall 142 of the junction box 102, and the mounting structure 110 may be attached to the bottom wall 144 of the driver housing 104. To illustrate, the mounting structure 110 may be attached to the bottom wall 142 using one or more fasteners 148, and the mounting structure 110 may be attached to the bottom wall 144 using one or more fasteners 150. The mounting structure 108 may include a mounting hole 120, and the mounting structure 110 may include a mounting hole 128. To securely attach the pivotable junction box and driver housing unit 100 to the ceiling inside the plenum space, a fastener (not shown), such as a nail or a screw, may be inserted through the mounting hole 120 and/or another fastener may be inserted through the mounting hole 128.

In some example embodiments, the junction box 102 may include one or more knockouts 140 in the side wall 134. For example, the one of the knockouts 140 may be removed to route a power supply cable through the opening that is formed when the knockout is removed. In some example embodiments, the junction box 102 may include one or more knockouts 146 that may be used to route one or more power supply cables through the opening(s) formed when one or more of the knockouts 146 are removed.

In some example embodiments, the pivotable junction box and driver housing unit 100 may include a latch 114 that is used to retain the junction box 102 and the driver housing 104 in the linear position shown in FIGS. 1A-1C. The latch 114 may be rotatably attached to the top cover 124 of the driver housing 104 by a fastener 136 (e.g., a rivet, a screw, etc.) such that the latch 114 is, for example, rotatable with respect to the fastener 136. A latch post 138 may be attached to the top cover 112 of the junction box 102 such that a hook end portion of the latch 114 may be releasably attached to the latch post 138. When the latch 114 is attached to the latch post 138, the latch 114 retains the junction box 102 and the driver housing 104 in the linear positions as shown in FIGS. 1A-1C. To rotate the junction box 102 and/or the driver housing 104 relative to each other and with respect to the attachment areas of the fasteners 106, 130, the latch 114 is first released from the latch post 138 by rotating the latch 114 away from the latch post 138.

In some example embodiments, the junction box 102 and the driver housing 104 may each be made from sheet metal using methods such as stamping, etc. For example, aluminum and/or steel sheet metal may be used to make the junction box 102 and the driver housing 104. In some alternative embodiments, the junction box 102 and/or the driver housing 104 may have a different shape than shown without departing from the scope of this disclosure. In some alternative embodiments, instead of being attached to the top cover 124 of the driver housing 104, the latch 114 may be attached to the top cover 112 of the junction box 102 by a fastener and may be rotatable relative to the fastener. To illustrate, the latch post 138 may be attached to the top cover 124 and the latch 114 may be releasably attached to the latch post 138. In some alternative embodiments, instead of the latch 114, another releasable latching mechanism may be used to retain the junction box 102 and the driver housing 104 in the linear positions shown in FIGS. 1A-1C. In some example embodiments, the latching mechanism including the latch 114 and the post 138 may be omitted without departing from the scope of this disclosure.

In some alternative embodiments, a fastener that extends through the side walls 126, 132 of the driver housing 104 may be used in place of the fasteners 106, 130 to pivotably/rotatably attach the junction box 102 to the driver housing 104. In some alternative embodiments, the junction box 102 and the driver housing 104 may be hinged or otherwise pivotably/rotatably attached to each other using means other than the fasteners 106, 130 without departing from the scope of this disclosure. In some alternative embodiments, one or both of the mounting structures 108, 110 may be omitted or different mounting structures may be used without departing from the scope of this disclosure. In some example embodiments, the junction box 102 and the driver housing 104 may have different relative dimensions with respect to each other than shown without departing from the scope of this disclosure.

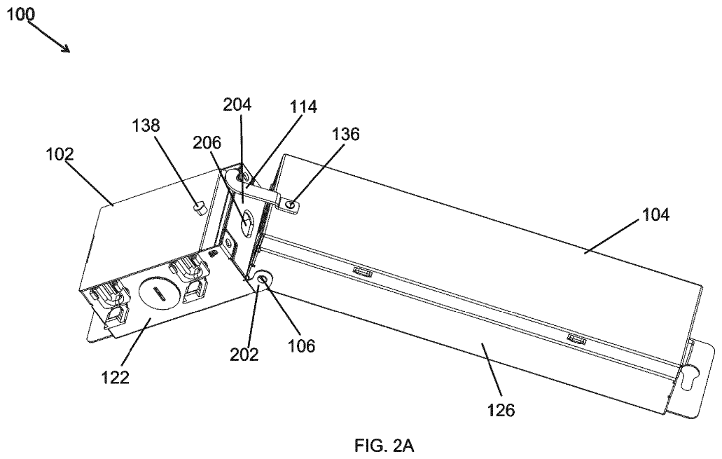

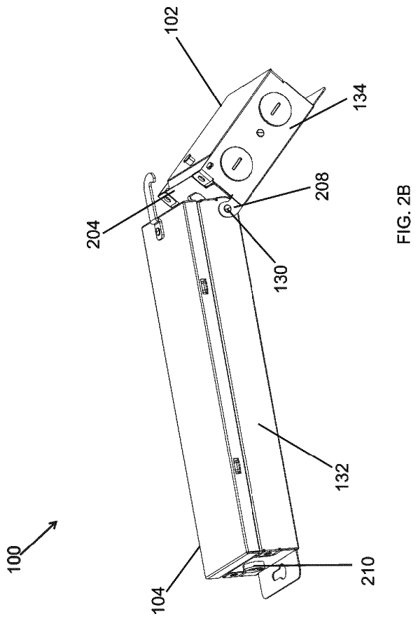

FIGS. 2A and 2B illustrate the pivotable junction box and driver housing unit 100 of FIGS. 1A-1C in a rotated position according to an example embodiment. Referring to FIGS. 1A-2B, in some example embodiments, the junction box 102 and the driver housing 104 may be rotated relative to each other. For example, the junction box 102 may be rotated relative to the driver housing 104 while the driver housing 104 remains in a fixed position. As another example, the driver housing 104 may be rotated relative to the junction box 102 while the junction box 102 remains in a fixed position. To allow the junction box 102 and/or the driver housing 104 to rotate, the latch 114 may first be released from the latch post 138 by rotating the latch 114 away from the latch post 138.

In some example embodiments, the junction box 102 may be rotated to the position shown in FIGS. 2A and 2B, which is less than 90 degrees from the linear position shown in FIG. 1A. In general, the junction box 102 may be rotated more or less than shown in FIGS. 2A and 2B. For example, the junction box 102 may be rotatable to a position that is up to 90 degrees or more from the linear position shown in FIG. 1A.

As described above, the fasteners 106, 130 rotatably attach the junction box 102 to the driver housing 104. To illustrate, the junction box 102 includes an attachment tab 202 shown in FIG. 2A and an attachment tab 208 shown in FIG. 2B. The attachment tab 202 may extend out from the side wall 122 of the junction box 102, and the attachment tab 208 may extend out from the side wall 134 of the junction box 102. The fastener 106 (e.g., a rivet) extends through a hole in the attachment tab 202 and a corresponding hole in the side wall 126 of the driver housing 104. The fastener 130 (e.g., a rivet) extends through a hole in the attachment tab 208 and a corresponding hole in the side wall 132 of the driver housing 104. The fasteners 106, 130 allow the junction box 102 and the driver housing 104 to be rotatable relative to each other while attached to each other by the fasteners 106, 130.

In some example embodiments, the junction box 102 includes a back wall 204 that includes a wire opening 206 for routing one or more electrical wires between the cavity of the junction box 102 and a driver that may be positioned inside the driver housing 104. For example, an electrical cable that is connected to a power supply cable inside the cavity of the junction box 102 may extend between the cavity of the junction box 102 and a driver inside the driver housing 104 through the opening 206.

In some example embodiments, the driver housing 104 may include another opening framed by a grommet 210 to route an electrical cable attached to a driver inside the driver housing 104. For example, an electrical cable extending through the opening having the grommet 210 may carry power that is provided by the driver, for example, to one or more light fixtures.

In some example embodiments, the pivotable junction box and driver housing unit 100 may be pivoted/rotated to the position shown in FIG. 2A and the degree of rotation may be changed as the driver housing 104 is inserted through a light fixture hole in a ceiling until the pivotable junction box and driver housing unit 100 passes entirely through the opening. The rotatability of the junction box 102 and the driver housing 104 relative to each other enables the pivotable junction box and driver housing unit 100 that contains a relatively large driver to be inserted through a relatively narrow light fixture opening and be placed in a relatively small plenum space (e.g., low height) behind a ceiling. The rotatability of the junction box 102 and the driver housing 104 relative to each other enables the pivotable junction box and driver housing unit 100 to be used instead of a junction box and a separate driver housing, which can result in, for example, in additional installation challenges. In some alternative embodiments, another type of hinge mechanism that does not include the attachment tabs 202, 208 may be used to rotatably attach the junction box 102 to the driver housing 104.

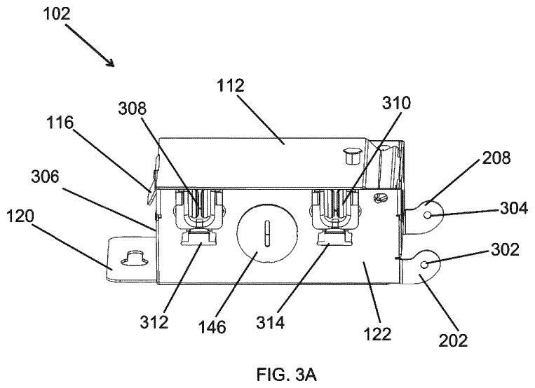

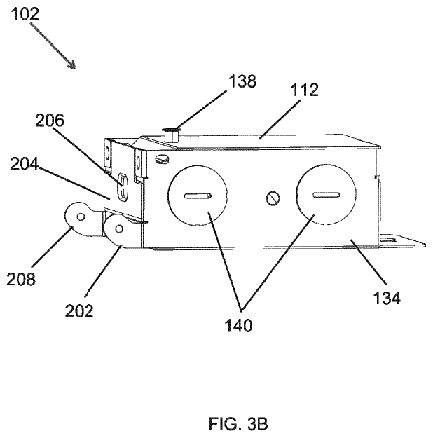

FIGS. 3A and 3B illustrate the junction box 102 of the pivotable junction box and driver housing unit 100 of FIGS. 1A-1C according to an example embodiment. Referring to FIGS. 1A-3B, in some example embodiments, the junction box 102 includes the top cover 112, the side walls 122, 134, the bottom wall 142, a back wall 204, and a front wall 306. The junction box 102 may include one or more knockouts 146 in the side wall 122, and one or more knockouts 140 in the side wall 134. As described above, one or more of the knockouts 140, 146 may be removed to route one or more electrical cables to and from the cavity of the junction box 102. The latch post 138 may be attached to the top cover 112. As described above, the top cover 112 may swing open or be fully lifted using the tab 116 to expose the cavity of the junction box 102.

In some example embodiments, the junction box 102 may include attachment tabs 202, 208. As described above, the attachment tab 202 may extend out from the side wall 122 of the junction box 102 beyond the back wall 204, and the attachment tab 208 may extend out from the side wall 134 of the junction box 102 beyond the back wall 204. The attachment tabs 202, 208 may be spaced from each other such that the attachment tabs 202, 208 are on the outside of the driver housing 104 on opposite sides of the driver housing 104 when the driver housing 104 is attached to the junction box 102.

In some example embodiments, the attachment tab 202 includes a hole 302, and the attachment tab 208 includes a hole 304. To attach the junction box 102 to the driver housing 104, the fastener 106 may be extended through the hole 302 and a corresponding hole in the side wall 126 and the fastener 130 may be extended through the hole 304 and a corresponding hole in the side wall 132.

In some example embodiments, the junction box 102 includes one or more grommet openings 308, 310 that may be used to route electrical wires therethrough between the inside and outside of the junction box 102. Each grommet opening 308, 310 may be closed by a respective cover 312, 314 when an electrical wire is not routed through the particular grommet opening 308, 310.

In some example embodiments, the tab 116 may be omitted or may be on a different side of the top cover 112 without departing from the scope of this disclosure. In some alternative embodiments, the attachment tabs 202, 208 may have a different shape than shown without departing from the scope of this disclosure. In some alternative embodiments, one or more of the knockouts 140, 146 and/or one or more of the grommet openings 308, 310 may be omitted without departing from the scope of this disclosure. In some alternative embodiments, the latch post 138 may be omitted without departing from the scope of this disclosure, for example, when the latch 114 is not included. In some alternative embodiments, the junction box 102 may have a different shape than shown without departing from the scope of this disclosure.

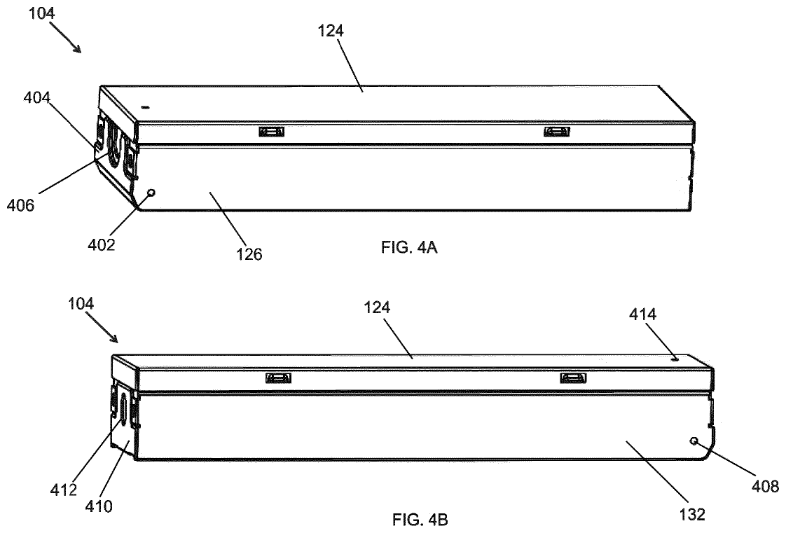

FIGS. 4A and 4B illustrate the driver housing 104 of the pivotable junction box and driver housing unit 100 of FIGS. 1A-1C according to an example embodiment. Referring to FIGS. 1A-4B, in some example embodiments, the driver housing 104 includes the top cover 124, the side walls 126, 132, the bottom wall 144, a front wall 404, and a back wall 410. The top cover 124 may be held attached to the side walls 126, 132, the front wall 404, and the back wall 410 by friction and may be opened, for example, by pulling or prying upward. The top cover 124 may include a fastener hole for attaching the latch 114 to the top cover 124 using the fastener 136. The cavity of the driver housing 104 may be sized to hold a driver (e.g., an LED driver) that can provide power to one or more (e.g., one, two, ten, etc.) light fixtures.

In some example embodiments, the side wall 126 of the driver housing 104 may include a hole 402, and the side wall 132 of the driver housing 104 may include a hole 408. The holes 402, 408 may be used in the attachment of the junction box 102 to the driver housing 104. For example, the fastener 106 may extend through the hole 302 in the attachment tab 202 of the junction box 102 and the hole 402 in the side wall 126, and the fastener 130 may be extended through the hole 304 in the attachment tab 208 of the junction box 102 and the hole 408 in the side wall 132. For example, the fasteners 106, 130 may each be a rivet or a screw-based fastener. Alternatively, instead of the fasteners 106, 130, a rod that extends through the respective holes 302, 304 of the attachment tabs 202, 208 and the holes 402, 408 in the side walls 126, 132 may be used to attach the junction box 102 to the driver housing 104. In some example embodiments, the driver housing 104 may include a wire opening 406 formed in the front wall 404. For example, a grommet or another protective material may be placed around the wire opening 406 to protect one or more electrical wires that extend through the wire opening 406 between a driver that may be in the cavity of the driver housing 104 and the cavity of the junction box 102.

In some example embodiments, the driver housing 104 may include a wire opening 412 formed in the back wall 410. The grommet 210 may be used at the opening 412, and an electrical cable may be routed between the inside and outside of the driver housing 104 through the opening 412. For example, the electrical cable may carry power that is provided by the driver, for example, to one or more light fixtures.

In some alternative embodiments, instead of the attachment tabs 202, 208, other attachment tabs functionally corresponding to the attachment tabs 202, 208 and that extend out from the side walls 126, 132 of the driver housing 104 may be used in the attachment of the junction box 102 to the driver housing 104 without departing from the scope of this disclosure. In some alternative embodiments, the driver housing 104 may have a different shape than shown without departing from the scope of this disclosure.

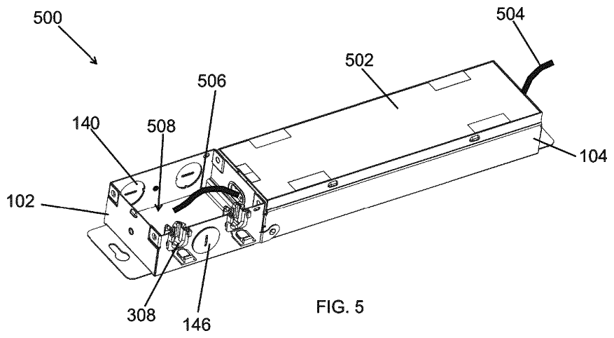

FIG. 5 illustrates a light fixture driver assembly 500 including the pivotable junction box and driver housing unit 100 of FIGS. 1A-1C according to an example embodiment. In FIG. 5, the driver housing 104 is shown without the top cover 124 to more clearly show a driver 502 that is positioned in the cavity of the driver housing 104. Also, in FIG. 5, the junction box 102 is shown without the top cover 112 for clarity of illustration. Referring to FIGS. 1A-5, in some example embodiments, the driver assembly 500 includes the pivotable junction box and driver housing unit 100 and the driver 502 (e.g., an LED driver). The driver 502 is positioned in a cavity of the driver housing 104. An electrical cable 504 (e.g., one or more electrical wires) connected to the driver 502 may extend out through the opening 412 in the back wall of the driver housing 104. For example, the electrical cable 504 may carry power that is provided by the driver 502 to one or more light fixtures.

In some example embodiments, an electrical cable 506 connected to the driver 502 may be routed to the cavity 508 of the junction box 102. The electrical cable 506 may extend between the cavity 508 and the driver 502 in the cavity of the driver housing 104 through the opening 406 in the front wall 404 of the driver housing 104 and through the opening 206 in the back wall 204 of the junction box 102. For example, the opening 406 and the opening 206 may be at least partially aligned with each other to facilitate the routing of the electrical cable 506. The electrical cable 506 may also have a rigidity that reduces a risk of the electrical cable 506 being trapped between the back wall 204 of the junction box 102 and the front wall 404 of the driver housing 104. The electrical cable 506 may also have enough length to accommodate the rotation of the junction box 102 and the driver housing 104 relative to each other.

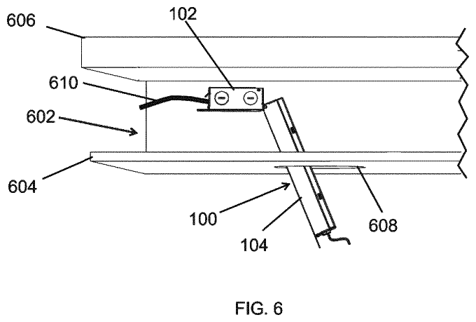

In some example embodiments, an electrical cable (e.g., electrical cable 610 shown in FIG. 6) designed to carry line power from a power supply, such as mains power supply, may be spliced with the electrical cable 506 inside the cavity 508 of the junction box 102. To illustrate, the line power electrical cable may be routed into the cavity 508 of the junction box 102 through an opening that is formed by removing one of the knockouts 140, 146. In some example embodiments, one or more electrical wires designed to carry one or more low voltage signals (e.g., driver control signals) may also be routed through, for example, the grommet opening 308 and may be spliced with respective electrical wires in the cavity 508 of the junction box 102.

FIG. 6 illustrates the pivotable junction box and driver housing unit 100 of FIGS. 1A-1C during installation in a plenum space 602 according to an example embodiment. Referring to FIGS. 1A-6, in some example embodiments, the driver 502 may be contained in the cavity of the driver housing 104. In some example embodiments, while the pivotable junction box and driver housing unit 100 is below a ceiling 604, a line power electrical cable 610 may be pulled down through an opening 608 in the ceiling 604 and may be spliced with the electrical cable 506 inside the cavity 508 of the junction box 102. When present, the latch 114 is released from the latch post 138, and the pivotable junction box and driver housing unit 100 is then inserted through the opening 608 into a plenum space 602 between the ceiling 604 and an upper building structure 606 (e.g., upper floor concrete). For example, the junction box 102 may be inserted first into the plenum space as shown in FIG. 6. Alternatively, the driver housing 104 containing the driver 502 may be inserted into the plenum space 602 before the junction box 102. When present, the latch 114 may be re-attached to the latch post 138 after the pivotable junction box and driver housing unit 100 is positioned entirely in the plenum space 602.

In some example embodiments, the pivotable junction box and driver housing unit 100 may be eventually positioned on the ceiling 604 inside the plenum space 602 after the driver housing 104 passes fully through the opening 608 when the junction box 102 is inserted through the opening 608 before the driver housing 104. When the driver housing 104 is inserted through the opening 608 before the junction box 102, the pivotable junction box and driver housing unit 100 is eventually positioned on the ceiling 604 inside the plenum space 602 after the junction box 102 passes fully through the opening 608. After the pivotable junction box and driver housing unit 100 is positioned on the ceiling 604 in a linear position, such as the linear position shown in FIG. 1A, the pivotable junction box and driver housing unit 100 may be secured to the ceiling using one or more fasteners that extend through one or both mounting holes 120, 128. In some alternative embodiments, the pivotable junction box and driver housing unit 100 may be placed on the ceiling 604 inside the plenum space 602 without being secured by fasteners. In some alternative embodiments, the pivotable junction box and driver housing unit 100 may be attached to another structure, such as a joist, behind the ceiling 604.

The pivotability/rotatability of the pivotable junction box and driver housing unit 100 enables the pivotable junction box and driver housing unit 100 to be used in small plenum spaces and/or with narrow light fixture openings. For example, the pivotable junction box and driver housing unit 100 may be used in small plenum space and/narrow light fixture openings where separate junction box and driver housing would otherwise be required or other comprises would otherwise need to be made.

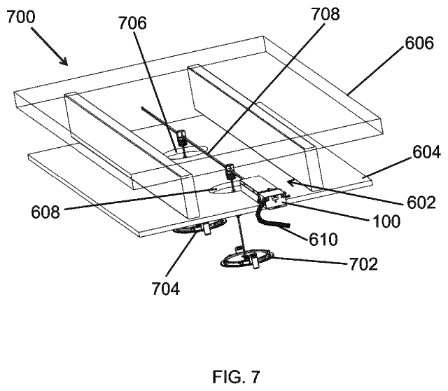

FIG. 7 illustrates a lighting system 700 including the pivotable junction box and driver housing unit 100 of FIGS. 1A-1C according to an example embodiment. Referring to FIGS. 1A-7, in some example embodiments, the system 700 includes light fixtures 702, 704 that are powered by the driver 502 that is inside the driver housing 104 via an electrical cable 708. For example, the light fixtures 702, 704 may be LED light fixtures. The electrical cable 708 may correspond to or may be connected to the electrical cable 504 shown in FIG. 5.

In some example embodiments, the pivotable junction box and driver housing unit 100 may be placed in the plenum space 602 in a similar manner as described above with respect to FIG. 6. For example, the pivotable junction box and driver housing unit 100 may be placed in the plenum space 602 through the light fixture opening 608 in the ceiling 604. The electrical cable 708 may be routed in the plenum space 602 between the ceiling 604 and the building structure 606 (shown in FIG. 7 as a transparent structure for illustrative purposes) before or after the pivotable junction box and driver housing unit 100 is placed in the plenum space 602. As described above, the line power electrical cable 610 may be spliced inside the cavity 508 of the junction box 102 with the electrical cable 506 connected to the driver 502.

After the pivotable junction box and driver housing unit 100 is positioned in the plenum space 602 and, optionally, secured, for example, to the ceiling 604, the light fixtures 702, 704, which may be surface mount light fixtures, may be attached to the ceiling 604 at the light fixture openings 608, 706. The light fixtures 702, 704 may provide illumination light to a space below the ceiling 604.

The rotatability of the junction box 102 and the driver housing 104 relative to each other enables the pivotable junction box and driver housing unit 100 that contains a relatively large driver that can provide power to multiple light fixtures to be placed in a relatively small plenum space through a relatively narrow light fixture opening.

In some example embodiments, the system 700 may include more or fewer than two light fixtures without departing from the scope of this disclosure. In some alternative embodiments, the pivotable junction box and driver housing unit 100 may be attached to a joist behind the ceiling 604 instead of to the ceiling 604.

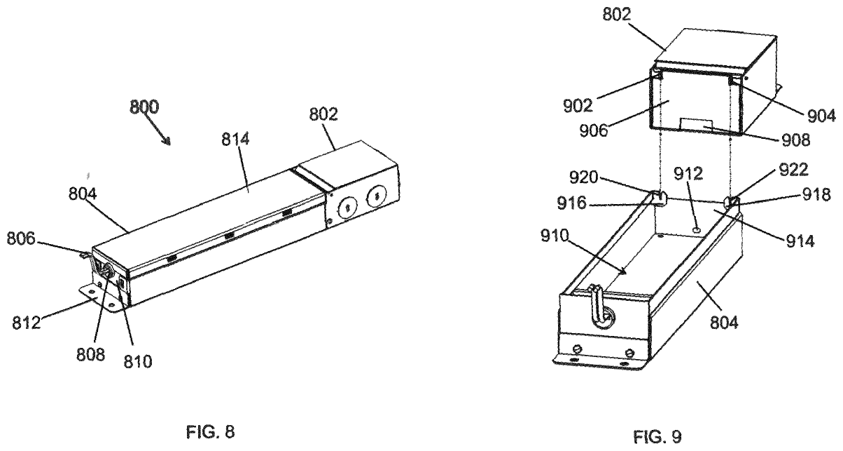

FIG. 8 illustrates a separable junction box and driver housing unit 800 according to an example embodiment. In some example embodiments, the separable junction box and driver housing unit 800 includes a junction box 802 and a driver housing 804. The junction box 802 and the driver housing 804 are attached to each other. In contrast to the junction box 102 and the driver housing 104 of the pivotable junction box and driver housing unit 100 of FIG. 1A, the junction box 802 and the driver housing 804 may not be rotatable with respect to each other while attached.

In some example embodiments, the junction box 802 and the driver housing 804 may be substantially similar to the junction box 102 and the driver housing 104, respectively, except with respect to the attachment mechanisms used for attachment to each other. For example, the driver housing 804 may contain the driver 502 shown in FIG. 5. The driver 502 may be accessed, for example, by removing and rotating the top cover 814 from the rest of the driver housing 804. An electrical cable 806 (e.g., one or more electrical wires) connected to the driver 502 in a cavity of the driver housing 804 may extend out through an opening 808 in a back wall 810 of the driver housing 804. For example, the electrical cable 504 may correspond to the electrical cable 504 and may carry power from the driver 502 to one or more light fixtures in a similar manner as described with respect to the pivotable junction box and driver housing unit 100 of FIG. 1A. An electrical cable (e.g., electrical cable 610 shown in FIG. 6) that is designed to carry line power from a power supply, such as mains power supply, may be spliced with another electrical cable (e.g., the electrical cable 506 shown in FIG. 5) inside the cavity of the junction box 802.

The driver housing 804 may be placed in a plenum space and secured to a structure (e.g., a joist) behind a ceiling (e.g., the ceiling 604) or to the ceiling itself using one or more fasteners that extend through one or more holes in a mounting structure 812 of the driver housing 804. In some alternative embodiments, the junction box 802 may also include a mounting structure that can be used to secure the junction box 802 to a joist or another structure in a plenum space behind a ceiling.

FIG. 9 illustrates the junction box 802 and the driver housing 804 of the separable junction box and driver housing unit 800 of FIG. 8 separated from each other according to an example embodiment. Referring to FIGS. 8 and 9, in some example embodiments, the junction box 802 may include tabs 902, 904 that protrude outwardly away from a back wall 906 of the junction box 802. The tabs 902, 904 are used to attach the junction box 802 to the driver housing 804. The junction box 802 may also include a wire opening 908 that is used to route one or more electrical wires between the cavity of the junction box 802 and a driver (e.g., the driver 502 shown in FIG. 5) that may be positioned in a cavity 910 of the driver housing 804. For example, one or more electrical wires may be routed between the cavity of the junction box 802 and the cavity 910 of the driver housing 804 through the wire opening 908 and a corresponding wire opening 912 formed in a front wall 914 of the driver housing 804. The driver housing 804 or the junction box 804 may include a wire strain relief structure (not shown) to protect the one or more electrical wires that may be extended between the junction box 802 and the driver housing 804.

In some example embodiments, the driver housing 804 may include attachment structures 916, 918. The attachment structure 916 may include a slot 920, and the attachment structure 918 may include a slot 922. To attach the junction box 802 to the driver housing 804, the tab 902 may be inserted in the slot 920 such that the attachment structure 916 prevents the tab 902 from detaching horizontally from the attachment structure 916. The tab 904 may also be inserted in the slot 922 such that the attachment structure 918 prevents the tab 904 from detaching horizontally from the attachment structure 918. To illustrate, when the separable junction box and driver housing unit 800 is oriented as shown in FIGS. 8 and 9, the tabs 902 and 904 may be vertically attached to and detached from the attachment structures 916 and 918, respectfully, as represented by the dotted lines shown in FIG. 9.

In some example embodiments, to install the separable junction box and driver housing unit 800 behind the ceiling 604 shown in FIG. 6, the driver housing 804 may be first placed in the plenum space 602 through the opening 608, and the junction box 802 may be subsequently and separately placed in the plenum space 602 through the opening 608 and attached to the driver housing 804 using the tabs 902, 904 and the attachment structures 916, 918. The driver housing 804 may be secured to the ceiling or a joist using one or more fasteners that extend through the one or more holes in the mounting structure 812 of the driver housing 804 before attaching the junction box 802 to the driver housing 804. In some alternative embodiments, the junction box 802 may be placed in the plenum space 602 before the driver housing 804, and the junction box 802 may then be attached to the driver housing 804 using the tabs 902, 904 and the attachment structures 916, 918.

The separability of the junction box 802 and the driver housing 804 from each other enables the separable junction box and driver housing unit 800 to be used in small plenum spaces and/or with narrow light fixture openings compared to a same size rigid unit. In some example embodiments, the separable junction box and driver housing unit 800 may be used instead of the pivotable junction box and driver housing unit 100 of FIG. 1A without departing from the scope of this disclosure.

In some alternative embodiments, the driver housing 804 may include the tabs 902, 904, and the junction box 802 may include the attachment structures 916, 918 without departing from the scope of this disclosure. In some alternative embodiments, the junction box 802 and the driver housing 804 may have different shapes than shown without departing from the scope of this disclosure.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the scope of the following claims, the scope of which are to be accorded the broadest interpretation so as to encompass modifications and equivalent structures.

1. A pivotable junction box and driver housing unit, comprising:
a junction box having a junction box cavity;
a driver housing having a driver housing cavity to contain a light fixture driver, wherein the junction box and the driver housing are attached to each other, wherein the junction box and the driver housing are rotatable with respect to each other, and wherein the junction box and the driver housing are rotatable to a linear position such that a first wire opening in a wall of the junction box aligned with a second wire opening in a wall of the driver housing; and
at least one electrical cable extending between the driver housing and the junction box through the first wire opening and the second wire opening, wherein the pivotable junction box and driver housing unit includes a latch, wherein when the latch is releasably engaged to a latch post the latch retains the junction box and the driver housing in a linear position preventing the junction box and the driver housing from rotating relative to each other and preventing access to or strain on the at least one electrical cable extending between the junction box and driver housing.

2. The pivotable junction box and driver housing unit of claim 1, wherein the junction box comprises attachment tabs that are positioned adjacent to side walls of the driver housing and wherein one or more fasteners extend through holes in the attachment tabs and the side walls of the driver housing to rotatably attach the junction box and the driver housing to each other.

3. The pivotable junction box and driver housing unit of claim 2, wherein the attachment tabs comprise a first attachment tab that is adjacent to a first side wall of the side walls of the driver housing and a second attachment tab that is adjacent to a second side wall of the side walls of the driver housing.

4. The pivotable junction box and driver housing unit of claim 3, wherein a first fastener of the one or more fasteners extends through a hole in the first attachment tab and a hole in the first side wall of the side walls, and wherein a second fastener of the one or more fasteners extends through a hole in the second attachment tab and a hole in second side wall of the side walls.

5. (canceled)

6. The pivotable junction box and driver housing unit of claim 1, wherein the wall of the junction box is adjacent to the wall of the driver housing when the junction box and the driver housing are in the linear position.

7. The pivotable junction box and driver housing unit of claim 1, further comprising a wire strain relief structure included with the junction box or driver housing.

8. The pivotable junction box and driver housing unit of claim 1, further comprising a mounting structure having a mounting hole for attaching the pivotable junction box and driver housing unit to a ceiling using a fastener that extends through the mounting hole.

9. A light fixture driver assembly, comprising:
a pivotable junction box and driver housing comprising:
a junction box having a junction box cavity;
a driver housing having a driver housing cavity, wherein the junction box and the driver housing are attached to each other, wherein the junction box and the driver housing are rotatable with respect to each other, and wherein the junction box and the driver housing are rotatable to a linear position such that a first wire opening in a wall of the junction box is aligned with a second wire opening in a wall of the driver housing;
at least one electrical cable extends between the driver housing and the junction box through the first wire opening and the second wire opening, wherein the pivotable junction box and driver housing unit includes a latch, wherein when the latch is releasably engaged to a latch post the latch retains the junction box and the driver housing in a linear position preventing the junction box and the driver housing from rotating relative to each other and preventing access to or strain on the at least one electrical cable extending between the junction box and driver housing; and
a light fixture driver positioned in the driver housing cavity.

10. The light fixture driver assembly of claim 9, wherein junction box comprises attachment tabs that are positioned adjacent to side walls of the driver housing and wherein one or more fasteners extend through holes in the attachment tabs and the side walls of the driver housing to rotatably attach the junction box and the driver housing to each other.

11. The light fixture driver assembly of claim 10, wherein the attachment tabs comprise a first attachment tab that is adjacent to a first side wall of the side walls of the driver housing and a second attachment tab that is adjacent to a second side wall of the side walls of the driver housing.

12. The light fixture driver assembly of claim 11, wherein a first fastener of the one or more fasteners extends through a hole in the first attachment tab and a hole in the first side wall of the side walls, and wherein a second fastener of the one or more fasteners extends through a hole in the second attachment tab and a hole in second side wall of the side walls.

13. (canceled)

14. (canceled)

15. The light fixture driver assembly of claim 9, wherein the wall of the junction box is adjacent to the wall of the driver housing when the junction box and the driver housing are in the linear position.
